(19) United States
(12) Patent Application Publication
(10) Pub. No.: US 2004/0008123 A1
(43) Pub. Date: Jan. 15, 2004

(54) System and method for tracking medical devices

(75) Inventors: Curt Carrender, Morgan Hill, CA (US); Roger Stewart, Morgan Hill, CA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Battelle Memorial Institute, Richland, WA

(21) Appl. No.: 10/196,487

(22) Filed: Jul. 15, 2002

(51) Int. Cl. G08B 5/22

(52) U.S. Cl. 340/825.49; 235/492; 340/572.1

(57) ABSTRACT

A system for monitoring medical devices, such as pharmaceuticals and prescriptions, is provided that utilizes Radio-Frequency Identification (RFID) techniques is provided. The system includes an RFID tag associated with the medical device, the tag programmed with information about the device, such as data about the manufacture, distribution, and sale thereof. The system further includes a reader that interrogates the tag and updates a database regarding the condition of the tag. The information in the tag can be revised by the reader or by an associated detector as the condition of the medical device changes, such as its location, sale, use, shelf life, and disposal. The system can also be configured to enable financial transactions, such as between an insurer and a provider or between a financial institution and a medical facility.

### BACKGROUND OF THE INVENTION

1. Field of the Invention

The present invention pertains to the tagging and monitoring of medical devices, and moreover to remote detection of the distribution, sale, delivery, and condition of medical devices, particularly pharmaceuticals.

2. Description of the Related Art

Pharmaceuticals and their containers, related medical items, such as syringes, IV's, catheters, and dressings are used in both in-patient and out-patient treatment. Because these medical devices are expensive, involve rapid turnover, and are frequently controlled by government regulation, they must be carefully monitored.

The manufacture and distribution of these medical devices requires careful tracking to ensure timely delivery, continuous checking of the inventory to determine its status, including the shelf life of drugs, and careful tracking to monitor the location of controlled substances and to ensure timely delivery. Unauthorized use and theft of controlled substances results not only in financial loss but contributes to societal ills resulting from addiction to controlled substances.

There is also a need to ensure that physicians and pharmacists are authorized to prescribe and deliver drugs to authorized patients. It is also important to ensure that the correct medication and dosage is provided to a patient, and that it is opened and used in accordance with the prescribed terms. Physicians and pharmacists are liable for errors in prescriptions, and patients can be injured by the misuse of medications.

In addition to the foregoing, there is the need for correct reporting of the sale and distribution of these medical items to insurance companies and regulatory agencies to ensure that financial transactions are timely completed and payment is made under the correct insurance policy, and that government regulatory requirements are being met. This requires a large amount of data be acquired by medical professionals and institutions and reported to the respective agencies and insurers. In addition, patients require such data for providing payment instructions to financial institutions and insurers. Consequently, there is a need for a system that provides continual automated reporting of the foregoing information in a manner that is non-intrusive yet reliable and accurate.

### BRIEF SUMMARY OF THE INVENTION

The present invention is directed to a method and system for tracking medical devices, which includes pharmaceuticals, a prescription for pharmaceuticals, their containers, and devices for administering the same, including patches, swabs, syringes, IVs, catheters, dressings, and the like. In accordance with one embodiment of the invention, a Radio Frequency Identification (RFID) system is provided that includes an RFID tag adapted to be attached to a medical device, or as a part of the device or inside the device, and having stored thereon, or configured to point to, information about the device and configured to transmit the information upon interrogation.

In accordance with another aspect of the foregoing embodiment of the invention, the information stored on the tag can include information about an authorized user, such as the patient, manufacturer, including date of manufacture and shipping history, as well as information about the device itself, including its status as to location, times and frequency of usage, and remaining shelf life.

In accordance with yet another aspect of the foregoing embodiment, the tag is configured to be updated such that the stored information remains current as the condition of the device changes.

In accordance with still yet another aspect of the foregoing embodiment, the tag is configured to store and transmit transactional information, such as payment authorization.

In accordance with another embodiment of the invention, an RFID system for tracking medical devices is provided that includes an RFID tag adapted to be attached to a medical device and having stored thereon information about the device and to transmit the information upon interrogation thereof; and a reader configured to interrogate the tag and to receive the transmitted information from the tag. The tag may be powered by the interrogation signal from the reader, from ambient energy, or from a combination thereof.

In accordance with yet another embodiment of the invention, an RFID apparatus is provided that includes a container for pharmaceuticals; an RFID tag attached to the container; and a device associated with the container and coupled to the tag to provide information to the tag as to the status of the container. Status can include opening of the container, breaking of a conductive seal on the container, as well as the location of the container with respect to geographic reference points or movement of the container.

In accordance with yet another embodiment of the invention, an RFID reader is provided for querying medical devices in pharmacies, doctors' offices, hospitals, homes, and in the field for continual monitoring of device.

In accordance with another aspect of the foregoing embodiment, the reader is configured to link the device monitoring to a database for access by regulatory agencies, financial institutions, medical institutions, and the like. In addition to providing data, the reader is configured to initiate the transfer of funds from one party to another and to authorize other financial transactions.

In accordance with still yet a further aspect of the present invention, a medical prescription system is provided that includes a container for storing the prescription; and a tag associated with the container and configured with information regarding the prescription. In one embodiment the tag is configured with information regarding at least one of patient history, insurance, patient identification, hospital information, dosage, biometrics, government regulation, and physician information.

### BRIEF DESCRIPTION OF THE SEVERAL VIEWS OF THE DRAWINGS

The foregoing and other features and advantages of the present invention will be more readily appreciated as the same become better understood from the following detailed description when taken in conjunction with the accompanying drawings, wherein:

FIG. 1 is a block diagram of a system for tracking medical devices formed in accordance with the present invention;

FIG. 2 is a more detailed diagram of a tag and reader formed in accordance with the present invention; and

FIGS. 3A-3D illustrate a container with a detector and a tag circuit formed in accordance with the present invention.

### DETAILED DESCRIPTION OF THE INVENTION

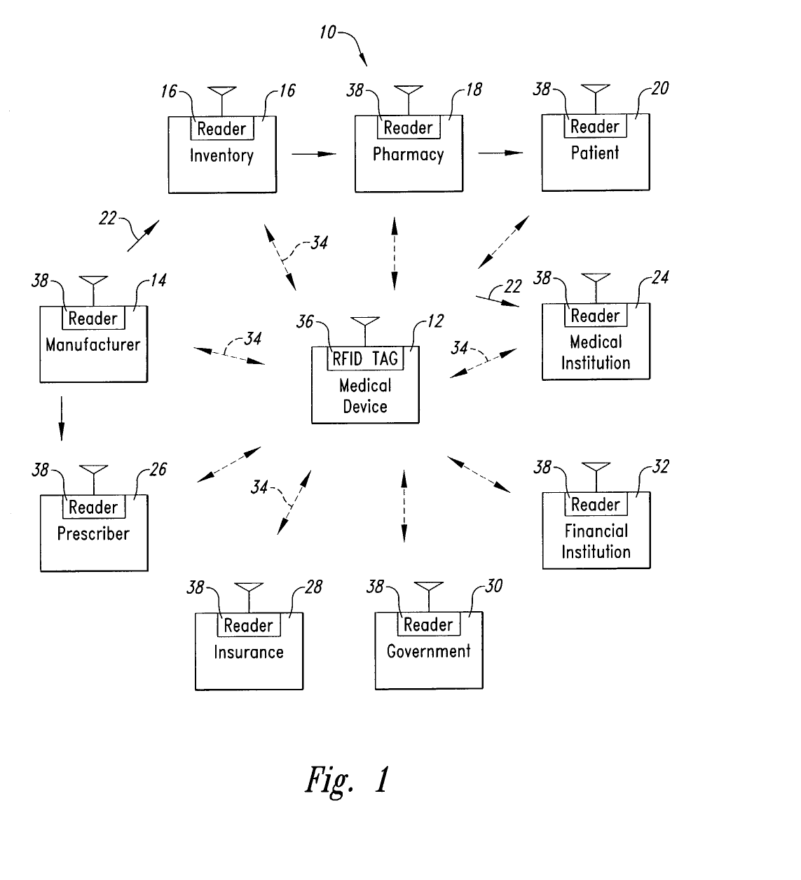

Referring initially to FIG. 1, shown therein is a block diagram representation of a system 10 for tagging and tracking a medical device 12. It is to be understood that the medical device 12 can be a pharmaceutical, such as a controlled substance, or a related medical item such as a container for the pharmaceutical, a syringe or IV for administering the pharmaceutical, a catheter, a medical implant, swab, patch, dressing, orthotic, and other medical supplies and equipment. While a preferred embodiment of the invention will be illustrated and described with respect to pharmaceuticals, it is to be understood that the invention will have broader applications.

Also shown in FIG. 1 is a block representation of the manufacturer 14 of the medical device 12 and the inventory 16 where newly manufactured devices are stored. One possible distribution path is to a pharmacy 18 from which the medical device 12 is delivered to the consumer or patient 20. The solid lines with arrowheads 22 indicate possible distribution channels for the medical device 12. One possible distribution channel is from the manufacturer's inventory 16 to a medical institution 24, such as a hospital or doctor's office. The inventory 16 may also represent a warehouse maintained by a distributor at a local or regional facility. The medical device 12 may also be distributed to the prescriber 26, such as a physician or clinic.

Also shown in FIG. 1 are an insurance provider 28, government agency 30, and financial institution 32. The dotted lines 34 with arrowheads indicate communication links between each of the entities listed above and the medical device 12 in accordance with the system and method of the present invention, which is described in more detail below. It is to be further understood that while the system 10 illustrated in FIG. 1 shows interaction among each of the entities and further between each entity and the medical device, it is to be understood that the system can be applied between only one entity and a medical device or the system can be applied to two or more entities with the medical device 12 or with multiple medical devices.

Communication with the medical device 12 takes place between an RFID tag 36 associated with the medical device 12 and an RFID reader 38 associated with each of the entities, as shown.

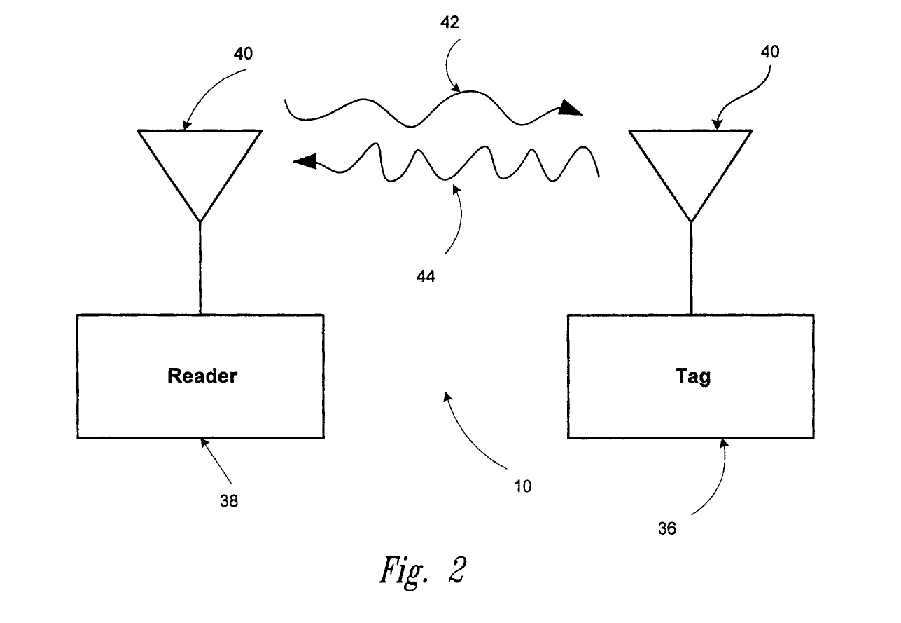

Referring next to FIG. 2, shown therein is a simplified diagram of the system 10 involving the reader 38 and the tag 36, both having an antenna 40. The reader 38 is configured to transmit an interrogation signal 42 that is received by the tag 36. In response thereto, the tag returns a modulated reflected signal 44 containing data or other information stored in the tag 36.

Communication using a passive (non-powered) device where an interrogation signal is modulated and reflected by the passive device is known and will not be described in detail herein. Briefly, backscatter communications involve selectively changing and reflecting the interrogation signal 42 by the tag 36. For example, modulating the radar cross section of a target causes energy reflected off the target to contain the information in its phase or amplitude modulation. The reader receiving the reflected energy is usually the device that has supplied the original energy required for this communication, and the reader 38 is configured to extract the data in the modulated reflected signal 44 by comparing the modulated reflected signal 44 to the original interrogation signal 42.

In RFID technology, commercial backscatter communications systems utilize microwave frequencies. In certain applications, the transceiver antenna 40 is a component of both a transceiver and a decoder in the reader 38, which makes the reader 38 an interrogator that can be configured either as a hand-held or fixed-mount device. The reader 38 emits the interrogation signal 42 in a range from one inch to one hundred feet or more, depending upon its power input and the radio frequency used. When an RFID tag 36 passes through the interrogation signal 42, the tag 36 detects the signal 42 and is activated. Data encoded in the tag 36 is then transmitted through reflection by the modulated signal 44 through the antenna 40 and to the reader 38 for subsequent processing.

When an RFID tag 36 is powered by the interrogation signal, it is referred to as a passive device because it derives the energy needed for operation from the radio frequency energy beamed at it. The tag 36 rectifies the field and dynamically changes the reflective characteristics of the tag antenna 40, creating a change in reflectivity that is seen at the reader 38. In contrast, a battery half empowered semi-passive RFID tag operates in a like fashion, modulating its RF cross section in order to reflect a delta to the reader 38 to develop a communication link. In this case, the battery is the source of the tag's operational power. In an active RFID tag, a transmitter is used to create its own radio frequency energy powered by the battery.

Both the tag 36 and the reader 38 of the disclosed embodiments of the invention may be formed using known techniques, including the fluidic self-assembly process disclosed in U.S. Pat. Nos. 6,291,896; 6,281,038; and 6,274,508, all of which are incorporated by reference herein in their entirety.

The tag 36 is configured to store, or to point to, information regarding the medical device 12 and its manufacture, distribution, sale, use, disposal after use, and payment thereof. This information can consist of data regarding the manufacture of the device 12, including the manufacturer, date of manufacture, shelf life, shipping date, lot number, as well as data regarding the inspection, inventory, and distribution of the device 12.

At each location, the reader 38 interrogates the tag 36 to identify the tag. Information about the tag is then updated on a database that is either associated with the reader 38, that is located at a remote location and coupled to the reader 38, or both. A prescribing physician 26 can provide information about the intended user of the device 12, such as a patient 20, and this information can be matched to the interrogated tag for verification and authentication. A verified user can then authorize payment from a financial institution 32 or insurer 28 to the correct party, such as the prescribing physician 26, the pharmacy 18, or a medical institution 24. In addition, governmental agencies 30 can utilize the information for tracking the device 12, especially in the case of controlled substances.

The tag used in conjunction with the medical device may be configured to enable programming of the tag to update the status of its condition. For example, the tag can be programmed by the manufacturer at the time of delivery to a pharmacy with information regarding the manufacture and delivery of the medical device. The pharmacy may then program the tag or use another tag to store information regarding the contents of the medical device and its condition, and in addition the device can be programmed with information regarding the specific prescription, the user, the prescriber, as well as payment and insurance information. This information can also be provided by a hospital, long-term care facility, or the prescribing physician as desired.

Ideally, the tag 36 is configured to be written to by the reader 38 in order to update the information regarding the tag. For example, when a tagged device 12 is transferred to a patient 20 by the pharmacy 18, the information is updated as to the location of the tag, date of sale, identity of the patient 38 by a reader, and financial information, such as insurance coverage and payment.

The condition of the tag 36 may also be monitored by using a device that detects a changed condition of the device 12. This can include, but is not limited to, detecting whether the device 12 has moved, where it is presently located, if and when it has been opened, and how many times it has been opened, and how much of the useful life of the device 12 has expired or remains. The detection of the changed condition can be accomplished in a variety of ways, including physical switches, Doppler radar, and the like.

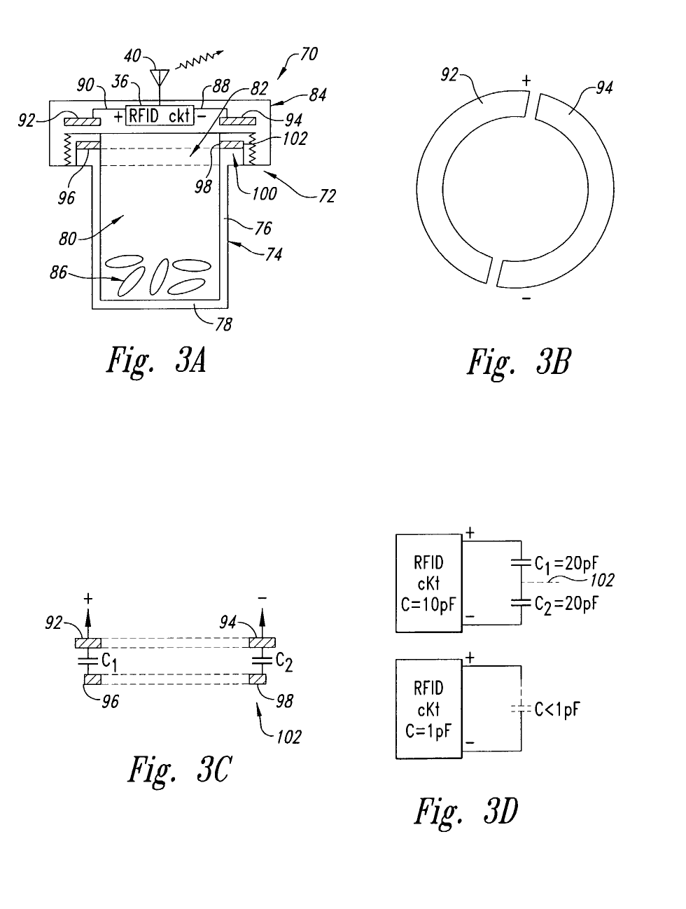

Referring to FIGS. 3A-3D, shown therein is an embodiment of the invention wherein a container 70 has an integrally-formed detector circuit 72 that is electrically coupled to the RFID tag 36. As shown in FIG. 3A, the container 70 includes a receptacle 74 having side walls 76 and a closed bottom 78 defining a hollow interior 80 that is accessed via an opening 82, which is covered by a cap 84. Pharmaceuticals, such as pills 86, are stored in the interior 80 of the receptacle 74. The cap 84 may be threadably engaged with the receptacle 74 or snapped thereon in a well-known manner that will not be described in detail herein. The RFID circuit 36 is integrally formed in the cap 84 and includes an antenna 40 that for purposes of illustration is shown extending from the cap 84, but is preferably integrally formed with the RFID tag 36 as part of the cap 84 and is generally not visible to a user.

Negative and positive leads 88, 90, respectively, extend from inputs to the RFID tag 36 to first and second arcuate metal segments 92, 94, respectively. The segments 92, 94 are shown in more detail in FIG. 3B. Ideally, the metal segments 92, 94 are embedded or formed in association with the cap 84.

Also shown in FIG. 3 are corresponding first and second terminals 96, 98 formed in the rim 100 of the receptacle 74. More particularly, the first and second plates 96, 98 are formed from a single metal ring 102 that circumscribes the opening 82 to the receptacle 84. As shown in FIG. 3C, the first plate 96 forms a capacitive element C1 with the first metal segment 92; and the second metal plate 98 forms a capacitive element C2 with the second metal segment 94.

The first and second plates 96, 98 form a common plate via the metal ring 102 to couple the first and second capacitive elements C1, C2 in series, as shown in FIG. 3D. For example, if the first and second capacitive elements C1, C2 were each 20 pF, the equivalent capacitance would be 0.1 pF, which is shown schematically in FIG. 3D.

When the cap 84 is removed from the receptacle 74, the capacitive circuit is broken. This is detected by the RFID tag 36, causing a change in its reflective characteristics. This in turn alters the backscattering characteristics of the tag 36, which is interpreted by a reader as a change in the condition of the container 70, i.e., that the cap has been removed.

Although a particular embodiment of the detection device has been illustrated and described, with respect to the detection device, it is to be understood that other methods may be used as known to those skilled in the art, including use of a resistive element, a conductor, an antenna, or other element that affects the. backscaftering characteristics of the tag 36. Simplicity, lightweight, and low cost are key factors in designing and implementing the detector. In addition, other elements can be provided, including an LED display for providing a visual indicator to a user of the status of the medical device, including the number of times the cap 70 has been removed, the remaining life of the prescription drug 86 or the expired portion of the life of the prescription drug 86, and a warning as to the condition of either the prescribed drug 86 or the container 70. Alternatively or in combination with the foregoing, an audible device may be incorporated into the container 70 to provide an aural form of communication, such as might be useful to the visually impaired. The foregoing devices are readily commercial available and will not be illustrated and described herein. The source of power for such devices can be a small power cell incorporated into the container 70 or ambient energy received via the antenna 40 on the RFID tag 36, or energy from an interrogation signal sent from a remote reader.

Movement of the container 70 can also be detected utilizing quadrature null techniques implemented in the RFID monitoring system.

A timer circuit of known construction can be employed to provide information to both the tag 36 and the display as to the life of the prescription drug 86.

While a container 70 has been described as having a lid 84 on a receptacle 74, it is to be understood that containers in the form of blister packs may be used where a tag is embodied in the blister pack. In one form, the tag can be rendered inoperational at the time the blister pack is opened or the backscatter modulation characteristics of the tag can be modified by opening the blister pack.

In accordance with a further embodiment of the invention, the system can be programmed to initiate financial transactions, such as the transfer of funds for the medical device. This can include authorization by verifying the identity of the user, availability of insurance coverage or funds in a bank account, and the legitimacy of the prescription from the prescribing physician. Payment can be triggered by electronic debiting when the medical device is scanned at a register or when the device is physically removed from the facility or when a seal is broken or when usage has commenced. Payments can also include payment of taxes to the appropriate government agency as well as reporting on the condition of the medical device, such as its location and usage.

All of the information described above can be linked via a remote database. Such a database can be accessed via the Internet, a local intranet, such as in a hospital, or in a doctor's office or a patient's home office. Readers in each of the facilities can be linked to the Internet and the present condition of the medical device is automatically monitored and reported without need for input from a patient.

While representative embodiments of the invention have been illustrated and described, it is to be understood that various changes may be made therein without departing from the spirit and scope of the invention. Hence, the invention is to be limited only by the scope of the claims that follow and the equivalents thereof.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. An apparatus for tracking a medical device, comprising:
a Radio Frequency Identification (RFID) tag adapted for attachment to the medical device and having stored thereon information about the medical device and configured to transmit the information upon interrogation.

2. The apparatus of claim 1 wherein the RFID tag has stored thereon information about at least one of a cost of the medical device, insurance coverage for the medical device, government regulation pertaining to the medical device, cost of the medical device, the user of the medical device, the manufacturer of the medical device, the manufacture of the medical device, and a distributor of the medical device.

3. The apparatus of claim 1 wherein the RFID tag comprises a sensor configured to monitor at least one condition of the medical device and to update the stored information as the condition of the medical device changes.

4. The apparatus of claim 1, further comprising a reader configured to interrogate the RFID tag and to receive and store the information transmitted by the RFID tag.

5. A monitoring system, comprising:
a medical device; and
a Radio Frequency Identification (RFID) tag adapted for attachment to the medical device and having stored thereon information about the medical device and configured to transmit the information upon interrogation.

6. The system of claim 5 wherein the RFID tag has stored thereon information about at least one of a cost of the medical device, insurance coverage for the medical device, government regulation pertaining to the medical device, cost of the medical device, a user of the medical device, a manufacturer of the medical device, manufacture of the medical device, and distribution of the medical device.

7. The system of claim 5 wherein the RFID tag comprises a sensor to monitor at least one condition of the medical device and to update the stored information when the condition of the medical device changes.

8. The system of claim 5, further comprising a reader configured to interrogate the RFID tag and to receive and store the information transmitted by the RFID tag.

9. The system of claim 5, further comprising at least one of an audible display and a visual display configured to display information stored on the RFID tag.

10. A device for remote radio frequency (RF) interrogation of a prescription drug having a Radio Frequency Identification (RFID) tag associated therewith, the device comprising:
an RFID reader for monitoring prescription drug use, the reader configured for use in facilities where the prescription drug is stored, dispensed, and used, the reader further configured to interrogate tagged prescription drug containers and to receive information therefrom regarding the condition of the prescription drug.

11. The device of claim 10 wherein the reader is configured to receive information regarding the user of the prescription drug.

12. The device of claim 10 wherein the reader is configured to receive information regarding the facility where the prescription drug is stored, dispensed, and used.

13. The device of claim 10 wherein the reader is configured to receive information regarding the condition of a container in which the prescription drug is stored.

14. The device of claim 10 wherein the reader is configured to receive information regarding the location of the prescription drug, the access to the prescription drug, and environmental conditions of the prescription drug.

15. A monitoring system, comprising:
at least one medical device having at least one Radio Frequency Identification (RFID) tag associated therewith; and
a reader configured for real time monitoring on at least a periodic basis of the at least one tag and receiving information from the at least one tag regarding at least one from among the manufacture(?), inventory, sale, delivery, status, and use of the medical device.

16. The system of claim 15 wherein the RFID tag and RFID reader are configured to initiate a transfer of money from one party to another in response to a condition of the medical device.

17. The prescription drug container, comprising:
a receptacle having an openable lid;
a detection device to detect a condition of the lid; and
a tag associated with the receptacle and coupled to the detection device and configured to respond to interrogation and transmit the condition of the lid.

18. The container of claim 17 wherein the detection device comprises a capacitive element formed in the lid and the receptacle.

19. The container of claim 17 wherein the capacitive element comprises a first conductive element formed in the lid and a second conductive element formed in the receptacle so that when the lid is placed on the receptacle, the first and second conductive elements form a capacitive element.

20. A system for the remote, automated monitoring of drug usage, comprising:
a container for storing the drug, the container having an openable access point thereto;
a tag formed on the container and configured to detect the condition of the openable access point; and
a reader configured to interrogate the tag and to receive the information about the condition of the openable access point, the condition comprising at least one from among a location, container movement, opening of the openable access point, and breaking of a seal associated with the openable access point, and a remaining life of a prescription drug in the container, and the condition of the life of the prescription drug in the container.

21. A medical prescription system, comprising:
a container for storing the prescription; and
a tag associated with the container and configured with information regarding the prescription.

22. The system of claim 21, wherein the tag is configured with information regarding at least one of patient history, insurance, patient identification, hospital information, dosage, biometrics, government regulation, and physician information.
